(19) United States
(12) Patent Application Publication
(10) Pub. No.: US 2021/0150502 A1
(43) Pub. Date: May 20, 2021

(54) CLOUD BASED SELF CHECKOUT SYSTEM

(71) Applicant: AiFi Corp

(72) Inventors: Steve Gu, San Jose, CA (US); Ying Zheng, Santa Clara, CA (US)

(21) Appl. No.: 16/686,207

(22) Filed: Nov. 18, 2019

(51) Int. Cl. G06Q 20/20; G06K 9/00; G07G 1/00

(52) U.S. Cl. CPC G06Q 20/203; G07G 1/0036; G06K 9/00771; G06Q 20/208

(57) ABSTRACT

The present invention describes a self checkout system with a cloud server. The system is configured to detect item change caused by customer actions and optimize the camera system and computing resources of a cloud server. The system also can distribute low confidence transactions to persons for review.

### BACKGROUND OF THE INVENTION

This application relates to systems, methods, devices, and other techniques for a self-checkout system utilizing cloud server and connections. The system also distributed low confident transaction to certain mobile devices of persons that can correct the incorrect transactions. These distributions are through cloud and internet connections.

The system is configured to detect items addition, removal or change caused by customer actions and optimizes computing resources of a cloud server. The system is also configured to sense items that are removed, added or misplaced automatically. The system also can coordinate the shelf, camera systems and LED lights to optimize shopping experience. The system also can utilize mirrors to widen the field of view of camera system. The system also utilize cloud server to calculate price and confidence level of the transactions.

Retail stores frequently display products on shelves for easy accessibility by customers. A shelf may be attached to a wall, a shelf, a stand, or any other surface. Typically, one or more products or items are placed on a shelf. A shelf sometimes includes a label or other signage indicating the name or type of items placed on a shelf. Customers can frequently remove, add or change items on a shelf.

Therefore, it is desirable to have a shelf system that is configured to detect actions caused by customer actions and optimize the camera system and computing resources of a cloud server. Also it is beneficial to have the system sense items that are removed, added or misplaced automatically. Also it is beneficial to have LED lights blinking to guide customers based on their previous choices and some predetermined patterns. Also it is beneficial to have a cloud server to connect to the system so that the server can calculate price and confidence level of the transactions. The system also distributed low confident transaction to certain mobile devices of persons that can correct the incorrect transactions. These distributions are through cloud and internet connections.

### SUMMARY OF THE INVENTION

This application relates to systems, methods, devices, and other techniques for a smart shelf of monitoring items coupled with support utilities. The system is configured to detect items addition, removal or change caused by customer actions and optimizes computing resources of a cloud server. The system is also configured to sense items that are removed, added or misplaced automatically. The system also can coordinate the shelf, camera systems and LED lights to optimize shopping experience. The system also can utilize mirrors to widen and deepen the field of view of camera system. The system also utilize cloud server to calculate price and confidence level of the transactions. The system also distributed low confident transaction to certain mobile devices of persons that can correct the incorrect transactions. These distributions are through cloud and internet connections.

In some embodiments, the invention is related to a shelf system that can improve shopping experiences, comprising: at least one shelf, wherein items are displayed on the at least one shelf; a set of cameras coupled to the self-checkout system, wherein the set of cameras is configured to capture video information of the items on the at least one shelf, wherein the set of cameras is configured to track any shopper; and a cloud based server coupled to a data processing device and the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the shelf system, wherein the cloud based server is configured to compute total price of the item removed by a shopper of the any shopper and charge the shopper the total price of the items and count as an transaction, wherein the transaction is configured to be evaluated to by artificial intelligence and is given a confidence level, wherein the transaction with the confidence level lower than a pre-determined value is distributed to a set of persons via mobile devices for manual review, wherein the set of person can correct any errors during the manual review. In some embodiments, a set of load sensors are placed on each corner of the at least one shelf, wherein the set of load sensors are configured to measure load data placed at the each corner of the at least one shelf. In some embodiments, the set of load sensors and the set of cameras are using power over Ethernet. In some embodiments, a set of indicators are coupled to the shelf system, wherein each of the set of indicators is placed under each item coupled to the shelf system, wherein the each of the set of indicators is configured to blink when the each item above the each of the set of indicators is removed.

In some embodiments, the invention is related to a shelf system that can improve shopping experiences, comprising: at least one shelf, wherein items are displayed on the at least one shelf; a set of cameras coupled to the shelf system, wherein the set of cameras is configured to capture video information of the item on the at least one shelf; a cloud based server coupled to the set of cameras via internet connections, wherein the cloud based server is configured to use computational resources to process the video information from the set of cameras, wherein the cloud based server is configured to receive information of the location of the item removed, wherein the cloud based server is configured to compute total price of the item removed by a shopper and charge the shopper the total price of the items and count as an transaction, wherein the transaction is configured to be evaluated by artificial intelligence and is given a confidence level, wherein the transaction with the confidence level lower than a pre-determined value is distributed to a set of persons via mobile devices for manual review, wherein the set of person can correct any errors during the manual review. In some embodiments, a set of load sensors are placed on each corner of the at least one shelf, wherein the set of load sensors are configured to measure load data placed at the each corner of the at least one shelf. In some embodiments, the set of load sensors, the set of cameras and the set of cameras are using power over Ethernet. In some embodiments, a set of visual indicators are coupled to the at least one shelf, wherein the set of visual indicators are coupled to blink to identify the geo-location of the at least one shelf, wherein the set of visual indicators are configured to blink pre-determined patterns to convey digital data to the cloud based server via the set of cameras, wherein one type of the digital data is unique ID of the at least one shelf, wherein the unique ID is related to the physical location of the at least one shelf, wherein the set of visual indicators are configured to direct a shopper to a specific item the shopper has purchased before, or an item on the shopper's request, or an item that has a special discount.

In some embodiments, the self-checkout system is comprising: at least one shelf, wherein items are displayed on the at least one shelf; a set of cameras coupled to the shelf system, wherein the set of cameras is configured to capture video information of the item on the at least one shelf, whereas another shelf contains a mirror on the another shelf's bottom, where the at least one shelf has a camera of the set of cameras pointing up at the mirror of the another shelf, with a field of view of any items on the at least one shelf; a cloud based server coupled to the set of cameras via internet connections, wherein the cloud based server is configured to use computational resources to process the video information from the set of cameras, wherein the cloud based server is configured to receive information of the location of the item removed, wherein the cloud based server is configured to compute total price of the item removed by a shopper and charge the shopper the total price of the items and count as an transaction, wherein the transaction is configured to be evaluated to by artificial intelligence and is given a confidence level, wherein the transaction with the confidence level lower than a pre-determined value is distributed to a set of persons via mobile devices for manual review, wherein the set of person can correct any errors during the manual review. In some embodiments, the network is connected by Ethernet. In some embodiments, the set of load sensors, the set of cameras and the set of cameras are using power over Ethernet. In some embodiments, the system is further comprising: a set of visual indicators coupled to the at least one shelf, wherein the set of visual indicators are coupled to blink to identify the geo-location of the at least one shelf, wherein the set of visual indicators are configured to blink pre-determined patterns to convey digital data to the cloud based server via the set of cameras, wherein one type of the digital data is unique ID of the at least one shelf, wherein the unique ID is related to the physical location of the at least one shelf, wherein the set of visual indicators are configured to direct a shopper to a specific item the shopper has purchased before, or an item on the shopper's request, or an item that has a special discount.

These and other aspects, their implementations and other features are described in details in the drawings, the description and the claims.

### BRIEF DESCRIPTION OF THE DRAWINGS

FIG. 1 shows an example diagram of a self checkout system with a cloud server.

FIG. 2 shows another example diagram of a self checkout system with a cloud server.

FIG. 3 shows a third example diagram of a self checkout system with a cloud server.

### DETAILED DESCRIPTION OF THE INVENTION

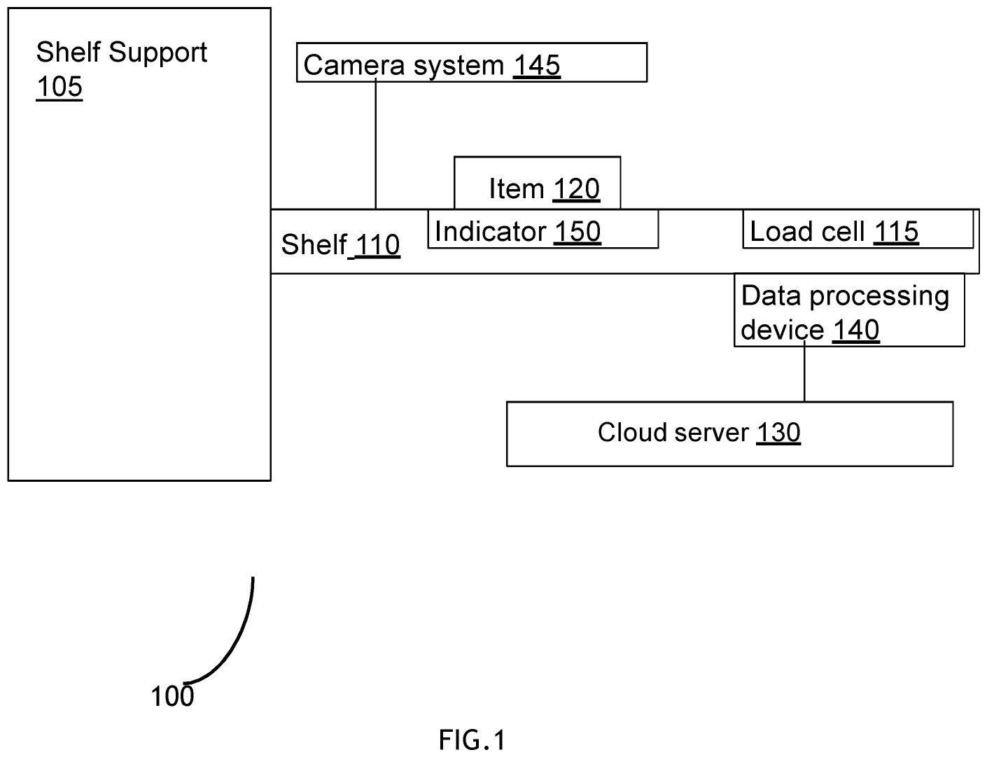

FIG. 1 shows an example diagram of a self checkout system with a cloud server.

In some implementations, the system 100 comprises a shelf support 105. In some embodiments, a shelf support can be represented as a board having a regular pattern of holes for inserting shelves, used chiefly for display of items or products. In some embodiments, a shelf support can be any means to attach multiple shelves with items for sale.

In some embodiments, the system comprises a shelf 110. In some embodiments, a shelf can be any shape of solid surface that items or products can be put on. In some embodiments, a shelf is attached physically to the shelf support 105. In some embodiments, multiple shelves are attached to the shelf support 105. In some embodiments, various computer chips, various sensors, different circuitry and other components may attach to the shelf 110.

In some embodiments, the load cells 115 are coupled to the shelf 110. In some embodiments, the load cells comprises different sensors, such as motion detecting sensors, force sensors, load sensors, weight sensors, light sensors and other sensors. In some embodiments, the load cells comprise processors. In some embodiments, the load cells comprise communication units. In some embodiments, the communication units are wireless communication units. In some embodiments, the communications units are wired communication units. In some embodiments, load cells are coupled to the cloud server 130 by a device processing device 140 via communication unit or units.

In some embodiments, item 120 is placed on the shelf 110. In some embodiments, multiple items are placed on the shelf 110.

In some embodiments, there are multiple shelves similar to the shelf 110 are coupled to the shelf support 105.

In some embodiments, the system may also includes the following features: camera system 145 coupled to the cloud server, wherein the camera system 145 is configured to have a field of view of the shelf 110, item 120 and other items, wherein the set of camera system 145 is used to track location information of a set of shoppers and item 120 and other items.

In some embodiments, a set of indicators 150 are coupled to the shelf system, wherein each of the set of indicators is placed under each item coupled to the shelf system, wherein the each of the set of indicators is configured to blink when the each item above the each of the set of indicators is removed. In some embodiments, the camera system 145 is configured to view both item 120 and indicator 150.

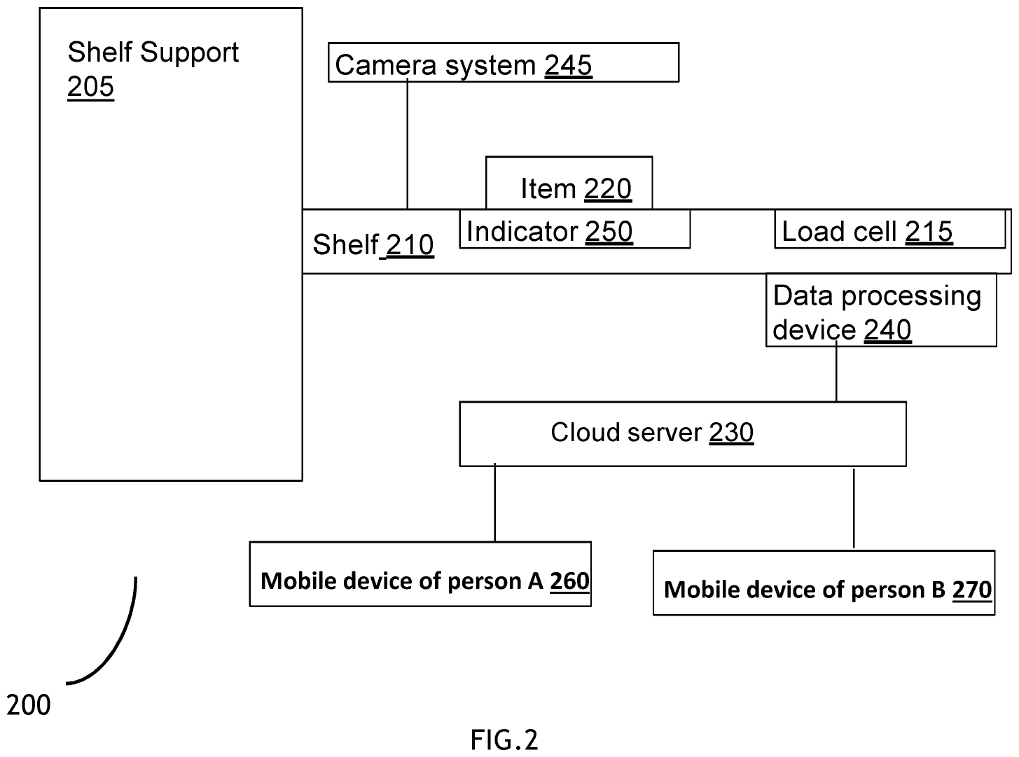

FIG. 2 shows another example diagram of a self checkout system with a cloud server.

In some implementations, the system 200 comprises a shelf support 205. In some embodiments, a shelf support can be represented as a board having a regular pattern of holes for inserting shelves, used chiefly for display of items or products. In some embodiments, a shelf support can be any means to attach multiple shelves with items for sale.

In some embodiments, the system comprises a shelf 210. In some embodiments, a shelf can be any shape of solid surface that items or products can be put on. In some embodiments, a shelf is attached physically to the shelf support 205. In some embodiments, multiple shelves are attached to the shelf support 205. In some embodiments, various computer chips, various sensors, different circuitry and other components may attach to the shelf 210.

In some embodiments, the load cells 215 are coupled to the shelf 210. In some embodiments, the load cells comprises different sensors, such as motion detecting sensors, force sensors, load sensors, weight sensors, light sensors and other sensors. In some embodiments, the load cells comprise processors. In some embodiments, the load cells comprise communication units. In some embodiments, the communication units are wireless communication units. In some embodiments, the communications units are wired communication units. In some embodiments, load cells are coupled to the cloud server 230 by a device processing device 240 via communication unit or units.

In some embodiments, item 220 is placed on the shelf 210. In some embodiments, in some embodiments, multiple items are placed on the shelf 210.

In some embodiments, there are multiple shelves similar to the shelf 210 are coupled to the shelf support 205.

In some embodiments, the system may also includes the following features: camera system 245 coupled to the cloud server, wherein the camera system 245 is configured to have a field of view of the shelf 210, item 220 and other items, wherein the set of camera system 245 is used to track location information of a set of shoppers and item 220 and other items.

In some embodiments, a set of indicators 250 are coupled to the shelf system, wherein each of the set of indicators is placed under each item coupled to the shelf system, wherein the each of the set of indicators is configured to blink when the each item above the each of the set of indicators is removed. In some embodiments, the camera system 245 is configured to view both item 220 and indicator 250

In some embodiments, the cloud based server 230 is configured to compute total price of the item removed by a shopper and charge the shopper the total price of the items and count as a transaction. In some embodiments, cloud server 230 make a determination based on Artificial intelligence calculation of the confidence level of any transactions. In some embodiments, the transaction with the confidence level lower than a pre-determined value is distributed to a set of persons via mobile devices for manual review, wherein the set of person can correct any errors during the manual review. In some embodiments, the mobile devices include Mobile device of person A 260 and Mobile device of person B 270.

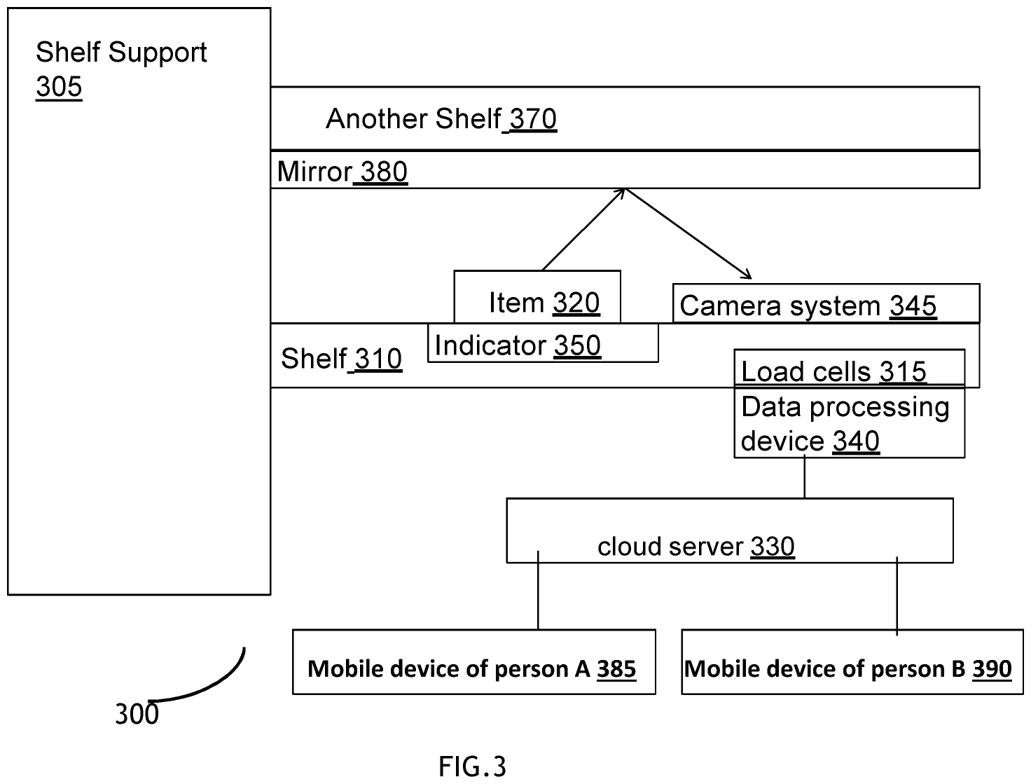

FIG. 3 shows a third example diagram of a self checkout system with a cloud server

In some implementations, in some implementations, the system 300 comprises a shelf support 305. In some embodiments, a shelf support can be represented as a board having a regular pattern of holes for inserting shelves, used chiefly for display of items or products.

In some embodiments, the system comprises a shelf 310. In some embodiments, a shelf can be any shape of solid surface that items or products can be put on. In some embodiments, a shelf is attached physically to the shelf support 305. In some embodiments, multiple shelves are attached to the shelf support 305. In some embodiments, various computer chips, various sensors, different circuitry and other components may attach to the shelf 310.

In some embodiments, the load cells 315 are coupled to the shelf 310. In some embodiments, the load cells comprises different sensors, such as motion detecting sensors, force sensors, load sensors, weight sensors, light sensors and other sensors. In some embodiments, the load cells comprise processors. In some embodiments, the load cells comprise communication units. In some embodiments, the communication units are wireless communication units. In some embodiments, the communications units are wired communication units. In some embodiments, load cells are coupled to the cloud server 330 by a device processing device 340 via communication unit or units.

In some embodiments, item 320 is placed on the shelf 310. In some embodiments, multiple items are placed on the shelf 310.

In some embodiments, there are other shelves similar to the shelf 310 are coupled to the shelf support 305.

In some embodiments, a set of indicators 350 are coupled to the shelf system, wherein each of the set of indicators is placed under each item coupled to the shelf system, wherein the each of the set of indicators is configured to blink when the each item above the each of the set of indicators is removed.

In some embodiments, another shelf 370 is placed above shelf 310. Another shelf 370 is also coupled to the shelf support 305. A mirror or mirrors 380 is coupled to the another shelf 370. A camera system 345 coupled to the shelf 310 and has a field of view of item 320 and indicator 350 via the mirror 380. Wider and deeper field of view of the camera system 345 can be achieved by the mirror 380.

In some embodiments, the shelf system 300 comprises: at least one smart shelf 310, wherein a set of load sensors 315 are placed on each corner of the at least one smart shelf, wherein the set of load sensors are configured to measure load data placed at the each corner of the at least one smart shelf; a data processing device 340 coupled to the set of load sensors, wherein the data processing device is configured to calculate weight and change in weight by combining the load data from the each corner of the at least one smart shelf, wherein the data processing device is configured to determine location of an item 320 removed or placed by calculating the location based on changes of load data at the each corner of the at least one smart shelf; a set of cameras 345 coupled to the shelf system, wherein the set of cameras is configured to capture video information of the item on the at least one smart shelf, whereas another shelf 370 contains a mirror 380 on the another shelf's bottom, where the at least one smart shelf has a camera of the set of cameras 345 pointing up at the mirror of the another shelf 370, with a field of view of any items on the at least one smart shelf; a cloud server 330 coupled to the data processing device and the set of cameras via a network, wherein the cloud server is configured to use computational resources to process the video information from the set of cameras, wherein the cloud server is configured to receive information of the location of the item removed or placed from the data processing device, wherein the cloud server is configured to prioritize computational resources to any cameras of the set of cameras with a view of the location of the item removed or placed from the data processing device, wherein a video image processing algorithm is used to identify the products removed, added or misplaced, wherein changes in weight are used to increase the confidence of identification of the products removed, added or misplaced; and a set of visual indicators 350 coupled to the at least one smart shelf 310, wherein the set of visual indicators 350 are coupled to blink to identify the geo-location of the at least one smart shelf, wherein the set of visual indicators are configured to blink pre-determined patterns to convey digital data to the cloud server via the set of cameras, wherein one type of the digital data is unique ID of the at least one smart shelf, wherein the unique ID is related to the physical location of the at least one smart shelf, wherein the set of visual indicators are configured to direct a shopper to a specific item the shopper has purchased before, or an item on the shopper's request, or an item that has a special discount.

In some embodiments, the cloud server 330 is configured to compute total price of the item removed by a shopper and charge the shopper the total price of the items and count as a transaction. In some embodiments, cloud server 330 make a determination based on Artificial intelligence calculation of the confidence level of any transactions. In some embodiments, the transaction with the confidence level lower than a pre-determined value is distributed to a set of persons via mobile devices for manual review, wherein the set of person can correct any errors during the manual review. In some embodiments, the mobile devices include Mobile device of person A 385 and Mobile device of person B 390.

In some embodiments, the network is connected by Ethernet. In some embodiments, the set of load sensors, the set of cameras and the set of cameras are using power over Ethernet.

1. A self-checkout system, comprising:
at least one shelf, wherein items are displayed on the at least one shelf;
a set of cameras coupled to the self-checkout system, wherein the set of cameras is configured to capture video information of the items on the at least one shelf, wherein the set of cameras is configured to track any shopper;
a cloud based server coupled to the set of cameras via internet connections, wherein the cloud based server is configured to use computational resources to process the video information from the set of cameras, wherein the cloud based server is configured to compute total price of the item removed by a shopper of the any shopper and charge the shopper the total price of the items and count as an transaction, wherein the transaction is given a number, wherein the transaction with the number lower than a pre-determined value is distributed to a set of persons via mobile devices for manual review, wherein the set of person can correct any errors during the manual review;
a set of visual indicators coupled to the at least one shelf, wherein the set of visual indicators are coupled to blink to identify geo-location of the at least one shelf, wherein the set of visual indicators are configured to blink patterns to convey digital data to the cloud based server via the set of cameras, wherein one type of the digital data is unique ID of the at least one shelf, wherein the unique ID is related to physical location of the at least one shelf, wherein the set of visual indicators are configured to direct a shopper to a specific item the shopper has purchased before, or an item on the shopper's request, or an item that has a special discount.

2. The self-checkout system of claim 1, further comprising: a set of load sensors that are placed on each corner of the at least one shelf, wherein the set of load sensors are configured to measure load data placed at the each corner of the at least one shelf.

3. The self-checkout system of claim 2, wherein the set of load sensors, the set of visual indicators and the set of cameras are using power over Ethernet.

4. The self-checkout system, further comprising:
a second set of indicators coupled to the shelf system, wherein each of the second set of indicators is placed under each item coupled to the shelf system, wherein the each of the second set of indicators is configured to blink when the each item above the each of the second set of indicators is removed.

5. A self-checkout system, comprising:
at least one shelf, wherein items are displayed on the at least one shelf;
a set of cameras coupled to the shelf system, wherein the set of cameras is configured to capture video information of the item on the at least one shelf;
a cloud based server coupled to the set of cameras via internet connections, wherein the cloud based server is configured to use computational resources to process the video information from the set of cameras, wherein the cloud based server is configured to receive information of the location of the item removed, wherein the cloud based server is configured to compute total price of the item removed by a shopper and charge the shopper the total price of the items and count as an transaction, wherein the transaction is given a number, wherein the transaction with the number lower than a pre-determined value is distributed to a set of persons via mobile devices for manual review, wherein the set of person can correct any errors during the manual review, and
a set of visual indicators coupled to the at least one shelf, wherein the set of visual indicators are coupled to blink to identify geo-location of the at least one shelf, wherein the set of visual indicators are configured to blink patterns to convey digital data to the cloud based server via the set of cameras, wherein one type of the digital data is unique ID of the at least one shelf, wherein the unique ID is related to physical location of the at least one shelf.

6. The self-checkout system of claim 5, further comprising: a set of load sensors that are placed on each corner of the at least one shelf, wherein the set of load sensors are configured to measure load data placed at the each corner of the at least one shelf.

7. The self-checkout system of claim 6, wherein the set of load sensors that are placed on each corner of the at least one shelf, and the set of cameras are using power over Ethernet.

8. The self-checkout system of claim 5, further comprising:
a second set of visual indicators that are configured to direct a shopper to a specific item the shopper has purchased before, or an item on the shopper's request, or an item that has a special discount.

9. A self-checkout system, comprising:
at least one shelf, wherein items are displayed on the at least one shelf;
a set of cameras coupled to the shelf system, wherein the set of cameras is configured to capture video information of the item on the at least one shelf, whereas another shelf contains a mirror on the another shelf's bottom, where the at least one shelf has a camera of the set of cameras pointing up at the mirror of the another shelf, with a field of view of any items on the at least one shelf;
a cloud based server coupled to the set of cameras via internet connections, wherein the cloud based server is configured to use computational resources to process the video information from the set of cameras, wherein the cloud based server is configured to receive information of the location of the item removed, wherein the cloud based server is configured to compute total price of the item removed by a shopper and charge the shopper the total price of the items and count as an transaction, wherein the transaction is given a number, wherein the transaction with the number lower than a pre-determined value is distributed to a set of persons via mobile devices for manual review, wherein the set of person can correct any errors during the manual review; and
a set of visual indicators coupled to the at least one shelf, wherein the set of visual indicators are coupled to blink to identify geo-location of the at least one shelf, wherein the set of visual indicators are configured to blink patterns to convey digital data to the cloud based server via the set of cameras, wherein one type of the digital data is unique ID of the at least one shelf, wherein the unique ID is related to physical location of the at least one shelf.

10. The self-checkout system of claim 9, further comprising: a set of load sensors that are placed on each corner of the at least one shelf, wherein the set of load sensors are configured to measure load data placed at the each corner of the at least one shelf.

11. The self-checkout system of claim 10, wherein the set of load sensors that are placed on each corner of the at least one shelf, and the set of cameras are using power over Ethernet.

12. The self-checkout system of claim 9, further comprising:
a second set of visual indicators that are configured to direct a shopper to a specific item the shopper has purchased before, or an item on the shopper's request, or an item that has a special discount.
